(19) United States
(12) Patent Application Publication
(10) Pub. No.: US 2019/0127195 A1
(43) Pub. Date: May 2, 2019

(54) DOUBLE LEVER CORKSCREW

(71) Applicant: PSP, Quigney (FR)

(72) Inventors: Samuel SAVATIER, Buffard (FR); Nicolas BROUILLAC, Saint Vit (FR)

(21) Appl. No.: 15/799,800

(22) Filed: Oct. 31, 2017

(30) Foreign Application Priority Data
Oct. 31, 2017 (FR) 16 60558

(51) Int. Cl. B67B 7/04

(52) U.S. Cl. CPC B67B 7/0447

(57) ABSTRACT

The double lever corkscrew includes a spiral metal rod secured to a rack, a tubular body housing the spiral metal rod, and two subassemblies. Each subassembly includes a lever arm and a toothed wheel meshing with the rack. The lever arms are movable between a folded-back position against the tubular body and a position spaced away from the tubular body. For each subassembly, the device for attaching the lever arm to the toothed wheel is arranged to pass from an active state and an inactive state. There is a device for holding the device for attaching in their inactive state when the lever arms are positioned in their folded-back position against the tubular body.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a corkscrew of the double lever type comprising:
a spiral metal rod having one free end and one end secured to a rack device,
a tubular body housing the spiral metal rod and having a lower section designed and able to fit the neck of a bottle and an upper section in the form of a guidance head in translation and rotation of the rack along and around the axis of the tubular body between a low position and a high position, wherein the free end of the spiral metal rod extends respectively in the low section and in a central section of the tubular body,
two assemblies, each comprising a lever arm and a toothed wheel meshing with the rack, mounted to rotate around an axis perpendicular to the axis of the tubular body on articulation shoulders bordering the guidance head, wherein the lever arms are movable between a folded-back position against the tubular body and a position away from the tubular body.
for each assembly, means for attaching the lever arm to the toothed wheel in order to pass to an active state, where the lever arm is attached to the toothed wheel, and to an inactive state, where the lever arm is detached from the toothed wheel.

### 2. Description of Related Art Including Information Disclosed Under 37 CFR 1.97 and 37 CFR 1.98

A corkscrew of the double lever type conventionally gives the possibility of facilitating the extraction of a cork from the neck of a bottle by sharing the traction force to be provided by the user to both arms.

Currently, double lever type corkscrews on the market have common structural features and may be grouped in two categories according to the nature of the corkscrews.

Thus, in a first category, double lever type corkscrews usually comprise a tubular body made of a rigid material, generally ZAMAK (registered trade mark), or another hard plastic on which two lever arms simultaneously rotate. These arms are extended with a partially-toothed wheel meshing with a rack fastened to the spiral metal rod and which moves in translation along the axis of the spiral metal rod between a low position and a high position. The implementation of such a double lever corkscrew according to this first category involves the following steps.

1. Positioning the corkscrew on the neck of a bottle, wherein both lever arms are lowered and folded back against the body of the corkscrew, and the rack is in the high position.

2. Grasping the corkscrew with one hand at the section comprising both lever arms and the bottle.

3. Grasping the handle extending the rack with the other hand.

4. Screwing the spiral metal rod into the cork while ensuring that the corkscrew and the bottle are held firmly in order to prevent any inadvertent rotation of the latter, until both lever arms begin to move away from the tubular body and reach their raised position.

5. Release of the corkscrew allowing the two lever arms to rise.

6. When the two lever arms have sufficiently risen, again holding the lower section of the tubular body and the bottle with one hand, and insertion of the spiral metal rod until the maximum travel of the two lever arms is reached.

7. Action of the two hands on the lever arms to position them in the low position against the tubular body and extraction of the cork.

8. Traction on the corkscrew by means of the handle fixed to the rack, in order to completely extract the cork, because the travel of the arms is usually not sufficient.

9. Firm gripping of the cork.

10. Simultaneous holding of the rack head and unscrewing the spiral metal rod to free the cork.

This type of corkscrew, examples of which are disclosed in the publications WO 03/031312 and DE 20 2009 004 857 have the disadvantage of requiring many user manipulations requiring a certain dexterity during use. These manipulations prove to be particularly onerous during most of the steps listed above. In particular, difficulties in handling have been noted upon inserting the spiral metal rod into the cork because, in this step, it is essential to simultaneously hold firmly the lower section of the corkscrew as well as the bottle to avoid it turning, which presupposes a certain physical strength. Moreover, the phase in which the lever arms begin to rise is also difficult and requires special care since the user must, for at least a few seconds, open his hand to allow movement of the lever arms. Finally, the complete withdrawal of the cork often requires an additional intervention by the user, while injuries due to accidental contact with the tip of the spiral metal rod upon unscrewing it from the cork, have also been reported.

The double lever arm corkscrews of the second category include, like those of the first category, a rigid tubular body, two lever arm and a rack in translation with respect to the axis of the spiral metal rod. In this second category, the corkscrews are further equipped with a system allowing detachment of the lever arms with respect to the rack provided with the spiral metal rod by means of a ratchet system. Such a structure thus avoids both lever arms being raised during the insertion of the spiral metal rod in the cork, and overcomes the difficulty of manipulating such corkscrews during this phase. Nevertheless, all the other drawbacks mentioned above with respect to the first category are always present in the corkscrews of the second category, which, therefore, are also not satisfactory.

### BRIEF SUMMARY OF THE INVENTION

The present invention has the object of proposing a double lever arm corkscrew having an innovative structure to overcome all of the drawbacks mentioned above, and thus provide a solution with improved ergonomics, the possibility for a user to extract the cork from the neck of a bottle easily, while offering ease of handling and not having to apply excessive force. Moreover, another object of the invention is to provide a corkscrew offering complete extraction of a cork from the neck of a bottle during its handling, while avoiding possible disintegration problems of the cork, sometimes observed due to excessive screwing in of the spiral metal rod into the cork.

For this purpose, the present invention relates to a corkscrew of the kind indicated in the preamble, characterized in that it comprises means for maintaining the attachment means in their inactive state when the lever arms are placed in their folded-back position against the tubular body.

In other words, the corkscrew according to the invention is equipped with means designed to prevent the attachment means from attaining their active position when the lever arms are folded-back against the body of the corkscrew. This is particularly advantageous during he screwing-in phase of the spiral metal rod into the cork, given that the lever arms are then immobile, unlike the lever arms of conventional corkscrews which move during this phase to attain their position away from the body of the corkscrew. Thus, by virtue of such a feature of the invention, the user is never hampered by the lever arms during handling, which, accordingly, is made less onerous.

According to a conceivable alternative embodiment of the invention, each toothed wheel comprises a shoulder extending between the base of its teeth and one of its faces, and wherein the means for attaching a lever arm to a toothed wheel comprise a member having at least one straight limb, mounted in order to be movable in translation along the longitudinal axis of the lever arm in a sheath with which the lever arm is provided, between a retracted position in the sheath corresponding to its inactive state, and a position partially extracted from the sheath corresponding to its active state, wherein an upper section of the straight limb engages in a notch, radially formed in the shoulder of the toothed wheel, wherein the passing of the member from its active state to its inactive state is carried out against an elastic restoring means that is inserted between a bottom comprised by the sheath and a lower edge of the member.

Moreover, in this case, the invention provides for each articulation shoulder to comprise at least one tab extending from the guidance head between a wall of the lever arm and the face of the toothed wheel forming the shoulder with the base of the teeth, while the width of the straight limb forming the member has a size substantially corresponding to the thickness of the tab plus the width of the notch, and wherein the sheath is formed on the lever arm so that the upper section of the member extends, during rotation of the lever arm, with respect to both the edge of the tab and of the notch, and wherein the edge of the tab forms a curve comprising a lower section of which the points are located at a distance from the axis that is larger than the radius of the faces of the toothed wheel and a lateral and upper section of which the points are located at a distance from the axis that is smaller than the radius of the faces of the toothed wheel.

According to a preferential alternative embodiment variant of the invention, the present corkscrew is characterized in that the member has a substantially U-shaped structure and comprises two straight limbs connected through a transverse limb, while each toothed wheel comprises two shoulders respectively extending between each of its faces and the base of its teeth, and two notches formed to face each other on each shoulder and designed to simultaneously receive the upper section of one of the straight limbs of the U-shaped member in the active state thereof, and wherein each articulation shoulder is formed by a pair of tabs each extending from the guidance head between a face of the toothed wheel and a front wall or rear wall of the lever arm.

In this case, it is provided that the notches are formed relatively to the space between two consecutive teeth, and wherein the distance between the upper face of the transverse U-shaped member and the upper edge of the straight limbs is larger than the height of one notch and smaller than the distance between the bottom of a notch and the apex of a tooth.

Moreover, according to an additional feature of the invention, the lower face of the transverse limb of the U-shaped member and the bottom of the sheath comprise coaxial recesses to house respectively the upper end and the lower end by means of the elastic restoring means.

The invention further provides for the sheath to extend along a transverse face of the lever arm between its front and rear faces.

Also it is conceivable that the tubular body has a frustoconical shape, wherein the diameter of its lower section is larger than the diameter of its central section, and wherein the peripheral wall of the tubular body comprises two longitudinal slots facing each other and extending the two articulation shoulders from the guidance head to the lower edge of the tubular body, and delimiting two longitudinal wings on the tubular body against which a lever arm rests in its folded-back position against the tubular body.

Preferably, it is provided for at least two longitudinal wings of the tubular body to be made of a deformable material.

Advantageously, the corkscrew according to the invention may further comprise means for blocking the rotation of the tubular body with respect to the neck of a bottle.

Moreover, the tubular body may comprise at its lower section, on the internal face of each of its longitudinal wings, a strip of an elastomeric material housed in a recess extending between the lower edge of the tubular body and a shoulder formed between the lower section and the central section of the tubular body.

Moreover, the tubular body preferentially has a length such that spiral metal rod remains entirely housed inside its lower section in the low position of the rack, while the lower edge of the tubular body has a supporting face on a plane extending between the internal face and the external face of its peripheral wall.

The corkscrew according to the invention is further characterized in that it may comprise means for indicating the screwing-in depth of the spiral metal rod into the cork of a bottle, which may be in the form of at least one mark applied on the rack and representative of a screwing-in depth of the spiral metal rod that should not be exceeded.

Other features and advantages of the invention will become apparent from the detailed description which follows, relating to an exemplary embodiment of the corkscrew according to the invention, but which is given only as an indication and not as a limitation.

### BRIEF DESCRIPTION OF THE SEVERAL VIEWS OF THE DRAWINGS

The understanding of this description will be facilitated by referring to the appended drawings.

FIG. 1 shows a perspective view of an overview of a corkscrew according to the invention in a first state of its various corresponding constitutive elements just before its implementation, wherein the lever arms have been lowered against the body and the rack is in a high position.

FIG. 2 shows a perspective view of the corkscrew of FIG. 1 positioned on the neck of a bottle to be opened.

FIG. 3 shows a perspective view of the corkscrew of FIG. 1 in a second state corresponding to just after the screwing in of the spiral metal rod into a cork, wherein the rack is in a low position and the lever arms are in a raised position.

FIG. 4 shows a longitudinal sectional view of the corkscrew of FIG. 3.

FIG. 5 shows an enlarged perspective view of a section of the corkscrew according to the invention showing the interaction between different constituent elements.

FIG. 6 shows a bottom perspective view of part of the corkscrew according to the invention.

### DETAILED DESCRIPTION OF THE INVENTION

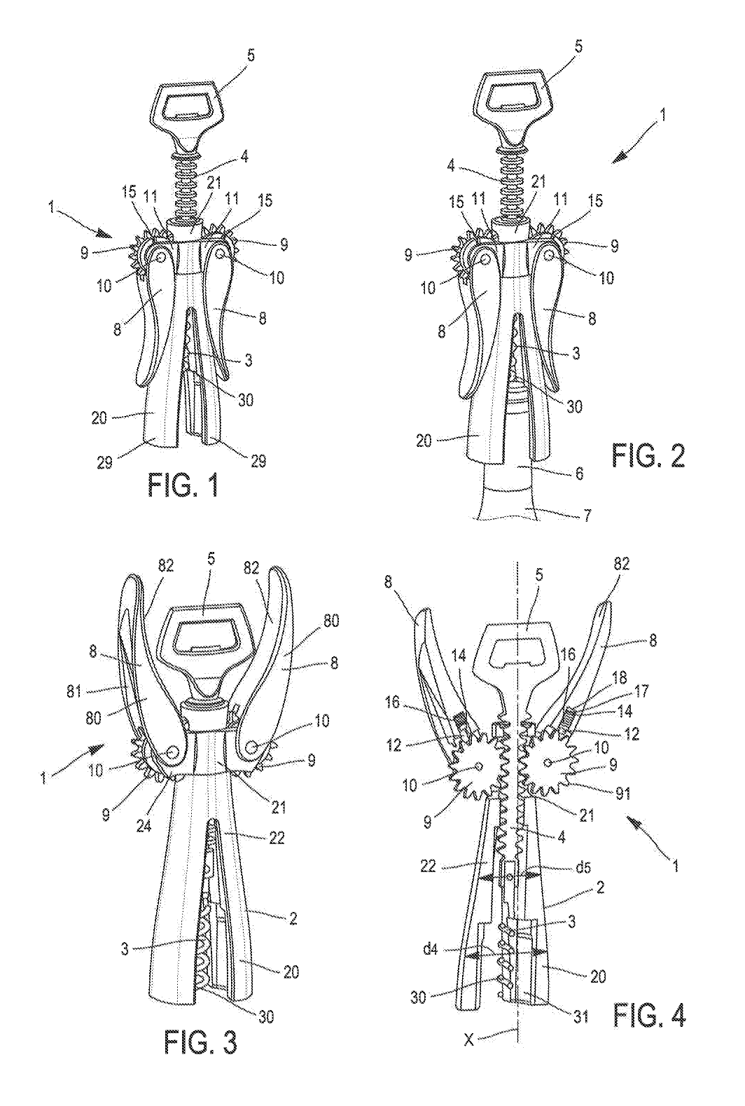

Conventionally, the corkscrew 1 according to the invention comprises a tubular body 2 housing a spiral metal rod 3 integral with a rack 4 extended by a handle 5 enabling it to be actuated. The tubular body 2 has a lower section 20 designed to fit the neck 6 of a bottle 7 and an upper section 21 defining a guidance head guiding in translation and rotation of the rack 4 along and around the axis of the tubular body 2 between a low position (see FIGS. 3 and 4) and a high position (see FIGS. 1 and 2) in which the free end 30 of the spiral metal rod 3 extends in the lower section 20 and in the upper position of a central section 22 of the tubular body 2 respectively.

The corkscrew 1 according to the invention further comprises two subassemblies, each comprising a lever arm 8 and a toothed wheel 9 engaging in the rack 4 through a window 37 formed in the upper section 21 of the tubular body 2. Each of these subassemblies is mounted to rotate about an axis 10 perpendicular to the axis of the tubular body 2, on an articulation shoulder 11 bordering the guidance head 21. Thus, the lever arms 8 may be displaced between a folded-back position against the tubular body 2 (see FIGS. 1 and 2) and a position spaced apart from the tubular body 2 (see FIGS. 3 and 4), in which they extend from one side to the other of the handle 5.

In addition, for each subassembly, the corkscrew 1 comprises means for fixing the lever arm 8 to the toothed wheel 9, wherein these securing means are arranged to pass to an active state in which the lever arm 8 is attached to the toothed wheel 9 and an inactive state in which the lever arm 8 is detached from the toothed wheel 9, wherein the latter is able to rotate without driving the lever arm 8 during its rotation.

In accordance with the invention, the corkscrew 1 advantageously comprises means for holding the attachment means in their inactive state when the lever arms 8 are positioned in their folded-back position against the tubular body 2. This has the advantage of eliminating the need for a user being required to manipulate the corkscrew 1, which disadvantage would involve the inevitable upward movement of the lever arms upon screwing in the spiral metal rod into the cork with the corkscrews of the prior art.

Thus, by virtue of this characteristic, with the corkscrew 1 according to the invention, a user no longer has to open and then close the hand holding the cork on the neck 6 of a bottle 7, during the screwing in of the spiral metal rod in order to allow the lever arms 8 to pass, wherein the latter remain totally immobile in their folded-back position against the body 2 of the corkscrew 1 during the entire step of screwing in the spiral metal rod 3 into a cork.

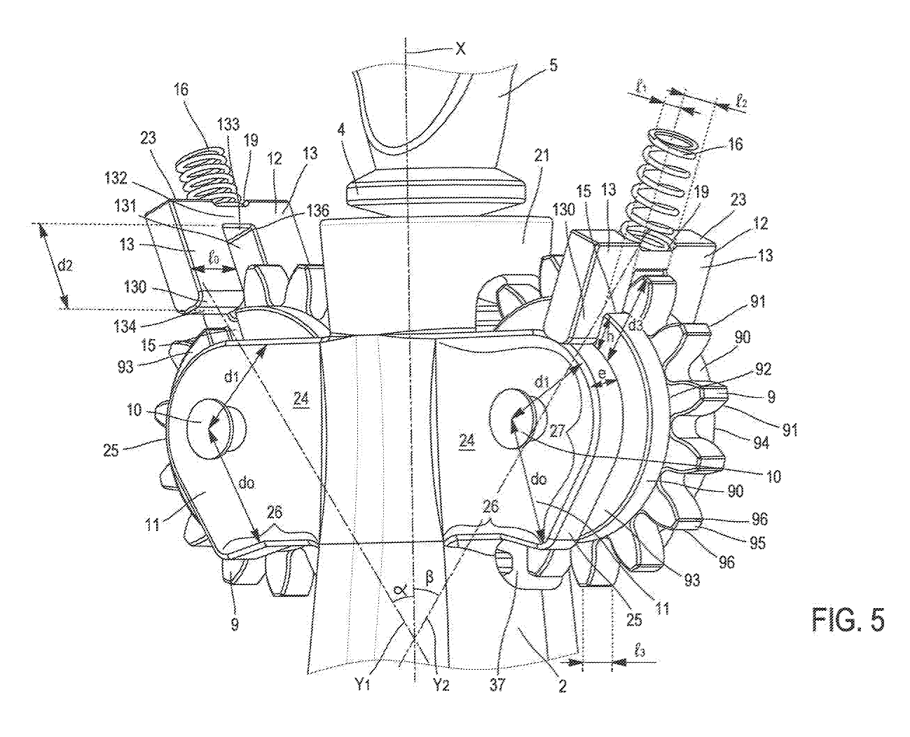

With reference to FIG. 5 in the embodiment variant illustrated, the means for attaching a lever arm 8 to a toothed wheel 9 comprise, on the one hand, a U-shaped member 12 having two straight limbs 13 connected by a transverse limb 132, and mounted so as to be movable in translation along the longitudinal axis of the lever arm 8 in a sheath 14 provided with the said lever arm 8, and, on the other hand, two notches 15 formed radially opposite one another in two shoulders 90 comprised by the toothed wheel 9, wherein the shoulders 90 extend on either side of the teeth 91 of the toothed wheel 9 between the base 92 thereof and one of the faces 93, 94 of the toothed wheel 9. Furthermore, it is provided that the notches 15 of each of the toothed wheels 9 are always located outside the windows 37 which comprise the upper part of the tubular body 2, whatever the position of the toothed wheels 9 with respect to the rack 4, while their axes Y1, Y2 form, with the axis X of the tubular body 2, angles α, β, that are preferably identical.

More precisely, the U-shaped member 12 is movable between a position inserted in the sheath 14 corresponding to an inactive state, and a position partially extracted from the sheath 14, corresponding to an active state, in which the upper sections 130 of each of the straight limbs 13 are engaged in one of the notches 15 comprises by the toothed wheel 9, while the rotation of each lever arm 8 then drives each toothed wheel 9, and vice versa.

It should be noted that the passing of the U-shaped member 12 from its active state to its inactive state is effected against a compression spring 16 or any other equivalent elastic restoring means inserted between a first recess 18 (see FIG. 4) in a bottom 17 formed by the sheath 14, and a second recess 19 extending coaxially on the lower face of the transverse limb 132 of the U-shaped member 12 with the first recess 19 and preferably along the axis of the interstice 131 between the two straight limbs 13.

Moreover, in the embodiment variant illustrated in the figures, each articulation shoulder 11 comprises a pair of tabs 24 extending from the guidance head in a symmetrical manner on either side of a plane containing the axis X of the tubular body 2.

Each toothed wheel 9 is housed between a pair of tabs 24 spaced apart from each other for this purpose by a distance slightly larger than the thickness of the toothed wheel 9. Furthermore, the two tabs 24 of a same pair are themselves inserted between a front face 80 and a rear face 81 comprised by each lever arm 8 (see FIG. 3).

Furthermore, the tabs 24, the toothed wheels 9, as well as the front and rear faces 80, 81 of the lever arms 8 are each provided with coaxial holes designed to allow the passage of the axle 10 through the assembly between them.

As may be seen in particular in FIG. 5, the edge 25 of each tab 24 also forms a curve of a special shape.

In fact, it comprises a lower section 26, the points of which are situated at a distance d0 from the axle 10 which is larger than the radius of the faces 93, 94 of a toothed wheel 9, wherein this lower section 26 is extended by a lateral and upper section 27 whose points are situated at a distance d1 from the axis 10 which is smaller than the radius of the faces 93, 94 of a toothed wheel 9.

It should also be noted that when the subassemblies are mounted on the articulation shoulders 11, the toothed wheels 9 are positioned in such a way that the notches 15 extend in front of the lateral and upper section 27 of the edge 25 of the tabs 24, and that the angles α, β are substantially identical.

In addition, in accordance with the invention, each straight limb 13 of a U-shaped member 12 has a width I0 substantially corresponding to the thickness e of a tab 24 plus the width I1 of a shoulder 90 and hence of a notch 15, whilst the sheath 14 is formed on each lever arm 8 preferably along a transverse face 82 between its front 80 and rear faces 81, and in such a way that the upper section 130 of each straight limb 13 of a U-shaped member 12 extends, when a lever arm 8 is rotated, against both the edge 25 of the tab 24 and the shoulder 90, and thus the notch 15, concerned. The interstice 131 extending between the two straight limbs 13 has a dimension I2 slightly larger than the thickness I3 of the teeth 91 of the toothed wheels 9.

According to an additional characteristic of the corkscrew 1 according to the invention, in the embodiment variant illustrated, the two notches 15 comprised by each toothed wheel 9 are formed with respect to a space comprised between two consecutive teeth 91. In addition, the distance d2 between the upper face 133 of the transverse limb 132 of the U-shaped member 12 and the upper edge 134 of its straight limbs 13 is larger than the height h of a notch 15, and smaller than the distance d3 between the bottom of a notch 15 and the apex 95 of a tooth 91. It should be noted that in addition, in the embodiment variant illustrated, the apex 95 of each tooth 91 is bordered by beveled edges 96, 97 (see FIG. 5). Likewise, the upper face 133 of the transverse limb 132 of the U-shaped member 12 is bordered by beveled edges 136.

By virtue of such a structure of the corkscrew 1 according to the invention, when the lever arms 8 are placed in their folded-back position against the tubular body 2, the U-shaped member 12, attached to each lever arm 8, is situated beneath the lower section 26 of the edge 25 of each tab 24. Since the points of this lower section 26 are situated at a distance d0 from the axis 10 which is larger than the radius of the faces 93, 94 of a toothed wheel 9, the lower section 26 of each tab 24 bears against the upper edge 134 of a straight limb 13 of the U-shaped member 12, and thus pushes the latter towards the bottom 17 of its sheath 14, while moving it away from the shoulders 90 of the gear wheel 9 concerned and by compressing the compression spring 16.

In other words, in their position folded-back against the tubular body 2, the lever arms 9 are inevitably detached from the toothed wheels 9 by virtue of the action of the lower section 26 of the edge 25 of the tabs 24 on the upper edges 134 of the limbs 13 of the U-shaped member 12, thus preventing any engagement of the latter in the notches 15, wherein the U-shaped member is thus held in its inactive position. A rotational movement of the toothed wheels 9 under the effect of a displacement of the rack 4 thus takes place independently of any rotational movement of the lever arms 8 which advantageously remain immobile in their folded-back position against the tubular body 2 without causing any discomfort to the user.

The user must therefore move the lever arms 8 himself between their folded-back position against the tubular body 2 and their position spaced away from the tubular body 2 and in which they are situated on either side of the handle 5.

During this phase, the U-shaped member 12 attached to each lever arm 8 performs a counter-clockwise rotational movement in the course of which it moves away from the lower section 26 of the edge 25 of each tab 24. When it reaches the lateral upper section 27, the upper edges of its straight limbs 13 are released from contact with the edge 25 of each tab 24 due to the change in profile of the latter with respect to the lower section 26. They then come into contact with each shoulder 90 of the toothed wheels 9. According to the invention, the compression spring 16 is always compressed in this position. Then, when the lever arm 8 continues its travel and reaches the height of the notches 15 formed in the shoulders 90, the latter no longer act on the upper edges 134 of the straight limbs 13 which then engage in the notches 15 underneath, wherein the effect of the release of the compression spring 16 thus placing the U-shaped member 12 in its active position. In this state, the toothed wheels 9 and the lever arms 8 mutually rotate.

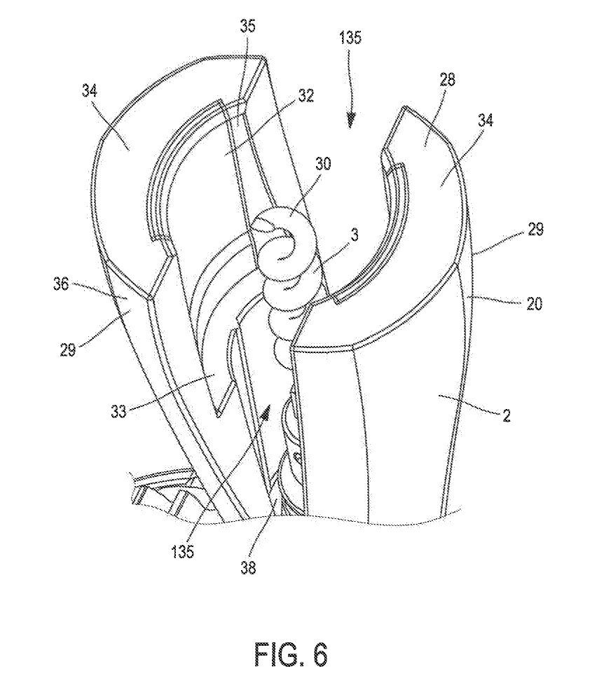

In order to achieve all of the objectives defined in the preamble, it has also been provided for the tubular body 2 to have a frustoconical shape in which the diameter d4 of its lower section 20 is larger than the diameter d5 of its central section 22. Moreover, in the embodiment variant illustrated, the peripheral wall of the tubular body 2 comprises two longitudinal slots 135 extending one opposite the other, between the two articulation shoulders 11, from the guidance head 21 to the lower edge 28 of the tubular body 2. These two longitudinal slots 135 define, on the tubular body 2, two longitudinal wings 29 (see FIG. 6), against each of which a lever arm 8 rests in its folded-back position against the tubular body 2 (see FIGS. 1 and 2).

In addition, the tubular body 2, or at least its two longitudinal wings 29, are preferably made of a deformable material, such as, for example, a deformable plastic material or any material having equivalent properties.

In addition, the tubular body 2 may also comprise, on each of its longitudinal wings 29 at its lower section 20, a strip 31 of an elastomeric material (see FIG. 4) housed in a recess 32 (see FIG. 6) extending on its inner face 35 between the lower edge 28 of the tubular body 2 and a shoulder 33 that is itself formed between the lower section 20 and the central section 22 of the tubular body 2.

The two strips 31 of an elastomeric material advantageously form means for blocking the corkscrew 1 against rotation with respect to the neck 6 of a bottle 7.

Moreover, the tubular body 2 of the corkscrew 1 also has the characteristic of being of such a length that the spiral metal rod 3 remains fully housed inside its lower section 20 in the low position of the rack 4, and thus avoids any risk of accidental injury to a user or inappropriate scratches on a plane on which the corkscrew 1 would have been placed vertically. In order to improve the stability of such positioning, the lower edge 28 of the tubular body 2 also has a bearing face 34 on a plane extending between the inner face 35 and the outer face 36 of its peripheral wall.

The corkscrew 1 according to the invention also has the advantage of comprising means for indicating the depth of the spiral metal rod 3 screwed into the cork of a bottle 7.

These may be, for example, in the form of at least one mark, such as a colored line applied to the rack 4, and representing a depth of the spiral metal rod 3 screwed into the cork, and which must not be exceeded. Such a reference mark, which appears in the longitudinal slots 135 of the body 2 during the screwing in of the spiral metal rod 3 into a cork and consequently during the translational movement towards its low position of the rack 4, thus constitutes a visual mark indicating to the user that a screwing-in depth has been reached, beyond which there a risk of disintegration of the cork leading to pieces of cork in the wine.

The use of the corkscrew 1 according to the invention and its advantages will now be described.

When a user wishes to extract a cork from the neck 6 of a bottle 7 by means of the corkscrew 1 according to the invention, he first places the latter in the state illustrated in FIG. 1, wherein the rack 4 is in its upper position and the two lever arms 8 are in their folded-back position against the two longitudinal wings 29 of the tubular body 2. As described above, in this state, each U-shaped member 12 is in its inactive state, while the lever arms 8 are thus detached from the toothed wheels 9.

The user then places the corkscrew 1 on the neck 6 of a bottle 7. This step is facilitated by the particular shape of the tubular body 2 and the use of a deformable material in its design. The presence of the strips 31 of an elastomeric material also makes it possible to avoid any risk of rotation of the corkscrew 1 during the screwing in of the spiral metal rod 3 into a cork, and saves the user from applying effort to avoid such a rotation.

The user then holds the bottle 7 with one hand at the level of its neck 6 through the lower part of the tubular body 2 without touching the bottle 7. The bottle 7 may also be positioned on a horizontal plane. In this case, the user does not need to support its weight. In any event, using his free hand, he may then undertake the screwing-in of the spiral metal rod 3 into the cork to be extracted, by actuating the handle 5. This causes the rack 4 to move towards its low position which is accompanied of a counter-clockwise rotation of the toothed wheels 9.

When the user considers that the desired screwing-in depth of the screw 3 into the cork has been reached, for example following the appearance of a corresponding mark applied to the rack 4 in a longitudinal slot 135, he releases the handle 5. According to the invention, the notches 15 of the toothed wheels 9 then extend on either side of the upper section 21 of the tubular body 2 in such a way that their axis Y1, Y2 is substantially parallel to the axis X of the tubular body 2. Accordingly, in this position, the axes Y1, Y2 of the notches 15 form an angle in the order of 180° with respect to the longitudinal axis of each lever arm 8.

As the bottle 7 is positioned on a horizontal plane, the user then uses his two hands to raise the two lever arms 8 and progressively place them in their position spaced away from the tubular body 2, wherein they extend on both sides, of the handle 5. This rotational movement of the lever arms 8 takes place independently of any rotation of the toothed wheels 9, which are still detached from the lever arms 8.

As described above, when the latter reach the height of the notches 15, the upper edges of the straight limbs 13 of each U-shaped member engage in the notches 15 and thus attach each lever arm 8 to a toothed wheel 9. In this position, the longitudinal axis of each lever arm forms an angle in the order of 0° with respect to the axis Y1, Y2 of a notch 15.

The user may then fully extract the cork from the neck 6 in a single movement, involving replacing the two lever arms 8 in their folded-back position against the tubular body 2 using both hands.

During this movement, each straight limb 13 of the U-shaped member 12, placed in its active position, wherein it presses against a wall of a notch 15. In addition, a beveled edge 136 of the upper face 133 of the transverse limb 132 of the U-shaped member bears on a beveled edge 96 comprised by each apex of a tooth 91. Consequently, the rotational movement of the lever arms 8 induces a 180° rotational movement in the clockwise direction of the toothed wheels 9, causing a displacement of the rack 3 to its high position. Such travel therefore advantageously allows complete extraction of a cork housed in the neck 6 through a single movement of the lever arms 8. Once extracted, the cork extends in the intermediate section 22 of the tubular body 2.

In this respect, the internal face 35 of the latter also has a second shoulder 38 on each longitudinal wing 29, and against which the top face of a cork abuts after its extraction from the neck 6. In order to release the cork from the body of the corkscrew 2 and the spiral metal rod 3, it is thus sufficient to unscrew the latter by means of the handle 5, while bringing the two lever arms 8 closer to each other towards the tubular body 2 in order to clamp the cork and avoid its rotation. The particular shape of the tubular body 2 then allows the cork to fall by itself, when the user ceases to act on the two lever arms 8.

As is clear from the foregoing, the corkscrew 1 according to the invention advantageously makes it possible to significantly reduce the number of steps required to uncork a bottle compared with a double lever corkscrew of the prior art as described in the introduction.

Moreover, it is characterized by perfect ergonomics when the spiral metal rod is inserted into the cork as a result of the deformable nature of the tubular body 2.

It also makes it possible to carry out the entire step of screwing the spiral metal rod 3 into a cork without having to hold it at the same time as the bottle 7.

It is also possible to screw the spiral metal rod 3 into the cork over the entire travel independently of any rotation of the lever arms 8, thereby making it possible to improve the handling of the corkscrew according to the invention compared with corkscrews of the prior art.

The presence of the means for indicating the depth of screwing in of the spiral metal rod 3 makes it possible to prevent any introduction of cork pieces into the wine in the bottle during the de-corking.

Moreover, the corkscrew 1 according to the invention allows extraction in a single step of corks of significant length (larger than 40 mm), while its structure makes it possible to ensure safe unscrewing of the spiral metal rod 3 at the end of its handling.

1. A corkscrew system comprising:
a spiral metal rod having a free end and an end secured to a rack,
a tubular body housing the spiral metal rod and having a lower section fit the neck of a bottle and an upper section forming a guidance head translating and rotating the rack along and around an axis of the tubular body between a low position and a high position in which the free end of the spiral metal rod extends respectively in the lower section and in a central section of the tubular body,
two subassemblies, each subassembly comprising a lever arm and a toothed wheel meshing with the rack, said two subassemblies being mounted to rotate around an axis perpendicular to the axis of the tubular body on articulation shoulders bordering the guidance head, wherein the lever arms are movable between a folded position against the tubular body and a position spaced away from the tubular body, for each subassembly, means for attaching the lever arm to the toothed wheel arranged to pass to an active state in which the lever arm is attached to the toothed wheel, and an inactive state in which the lever arm is detached from the toothed wheel, wherein the corkscrew is characterized in that it comprises means for holding the attachment means in their inactive state when the lever arms are positioned in their folded-back position against the tubular body.

2. The corkscrew, according to claim 1, wherein each toothed wheel comprises at least one shoulder extending between the base of its teeth and one of its faces, and wherein the said means for attaching a lever arm to a toothed wheel comprise a member having at least one straight limb mounted to be movable in translation along the longitudinal axis of the lever arm in a sheath comprised by the lever arm between a retracted position in the sheath corresponding to its inactive state, and a partially extracted position in which an upper section of the straight limb engages in a notch, formed in the shoulder of the toothed wheel, wherein the passing of the member from its active state to its inactive state is effected against a plastic restoring means inserted between a bottom comprised by the sheath and a lower edge of the member.

3. The corkscrew, according to claim 2, wherein each articulation shoulder comprises at least one tab extending from the guidance head between a wall of the lever arm and the face of the toothed wheel forming the shoulder with the base of the teeth, while the width of the straight limb forming the member has a dimension substantially corresponding to the thickness of the tab plus the width of the notch, and
wherein the sheath is formed on the lever arm in such a manner that the upper section of the member extends when the lever arm is rotated, with respect to both the edge of the tab and the notch, and wherein the edge of the tab forms a curve comprising a lower section whose points are situated at a distance d0 from the axis that is larger than the radius of the faces of the toothed wheel, and a lateral and upper section whose points are situated at a distance from the axis and which is smaller than the radius of the faces of the toothed wheel.

4. The corkscrew, according to claim 3, wherein the member has a substantially U-shaped structure and comprises two straight limbs connected by a transverse limb, while each toothed wheel has two shoulders respectively extending between each of its faces and the base of its teeth, and two notches formed facing one another on each shoulder and designed to receive simultaneously the upper section of one of the straight limbs of the U-shaped member in the active state thereof, and wherein each articulation shoulder consists of a pair of tabs each extending from the guidance head between a face of the toothed wheel and a front wall or rear wall of the lever arm.

5. The corkscrew, according to claim 4, wherein the notches are formed with respect to the space between two consecutive teeth, and wherein the distance between the upper face of the transverse limb of the U-shaped member and the upper edge of the straight limbs is larger than the height of a notch and smaller than the distance between the bottom of a notch and the apex of a tooth.

6. The corkscrew, according to claim 4, wherein the lower face of the transverse limb of the U-shaped member and the bottom of the sheath comprise coaxial recesses respectively designed to house the upper end and the lower end of the elastic restoring means.

7. The corkscrew, according to one of claim 4, wherein the sheath extends along a transverse face of the lever arm between its front face and its rear face.

8. The corkscrew, according to claim 1, wherein the tubular body has a frustoconical shape where the diameter of its lower section is larger than the diameter of its central section, and in that the peripheral wall of the tubular body has two mutually-facing longitudinal slots between the two articulation shoulders from the guidance head to the lower edge of the tubular body, and delimiting two longitudinal wings on the tubular body, against each of which a lever arm rests in its folded-back position against the lower edge of the tubular body.

9. The corkscrew, according to claim 4, wherein at least the two longitudinal wings of the tubular body are made of a deformable material.

10. The corkscrew, according to claim 8, further comprising: means for blocking the rotation of the tubular body with respect to a neck of a bottle.

11. The corkscrew, according to claim 10, wherein the tubular body has at its lower section on the inner face of each of the longitudinal wings, a strip of elastomeric material housed in a recess extending between the lower edge of the tubular body and a shoulder formed between the lower section and the central section of the tubular body.

12. The corkscrew, according to claim 1, wherein the tubular body has a length such that the spiral metal rod remains integrally housed inside its lower section in the lower position of the rack, and wherein the lower edge of the tubular body has a bearing surface on a plane extending between the inner face and the outer face of its peripheral wall.

13. The corkscrew, according to claim 1, further comprising: means for indicating the depth of screwing in of the spiral metal rod into the cork of a bottle.

14. The corkscrew, according to claim 13, wherein the indicating means comprise at least one mark applied to the rack, and which is representative of a depth of screwing in of the spiral metal rod into a cork and which is not to be exceeded.
